(19) United States
(12) Patent Application Publication
(10) Pub. No.: US 2026/0330966 A1
(43) Pub. Date: Oct. 22, 2026

(54) GEO-AWARE CONNECTED VEHICLE CORRIDOR SHARING IN 5G VEHICLE-TO-INFRASTRUCTURE NETWORKS

(71) Applicant: Nokia Solutions and Networks Oy, Espoo (FI)

(72) Inventors: Andrea ENRICI, Massy (FR); Bogdan USCUMLIC, Massy (FR)

(21) Appl. No.: 19/106,861

(22) PCT Filed: Aug. 31, 2022
(86) PCT No.: PCT/IB2022/058189

§ 371 Date: Feb. 26, 2025

(51) Int. Cl. G08G 1/01; G08G 1/017; G08G 1/065; H04W 4/44

(52) U.S. Cl. CPC G08G 1/0133; G08G 1/0175; G08G 1/065; H04W 4/44

(57) ABSTRACT

In a system, apparatus, method, and non-transitory computer readable medium, an intelligent transportation system node may be caused to, determine traffic condition information associated with a desired segment of a road network, the road network including at least one reserved lane, determine whether to dequeue at least one access request token from the plurality of input queues based on the determined traffic condition information and vehicle information corresponding to at least one vehicle associated with the at least one access request token, and transmit at least one reserved lane access token from a set of reserved lane access tokens to at least one vehicle corresponding to the at least one dequeued access request token, the at least one reserved lane access token instructing the at least one vehicle to access to the reserved lane.

### BACKGROUND

### Field

Various example embodiments relate to methods, apparatuses, systems, and/or non-transitory computer readable media for providing geo-aware connected vehicle corridor sharing in 5G vehicle-to-infrastructure networks.

### Description of the Related Art

A 5^{th} generation mobile network (5G) standard, referred to as 5G New Radio (NR), is being developed to provide higher capacity, higher reliability, and lower latency communications than the 4G long term evolution (LTE) standard.

With the deployment of 5^{th} generation mobile network (5G) networks and other high-speed networks, there has been increased proliferation of network-enabled devices and/or applications, such as autonomous vehicles, robots, Internet of Things (IoT) devices, industrial sensors, network-enabled medical devices, etc., which have been adapted to take advantage of the higher capacity, higher reliability, and lower latency communications service.

One proposed implementation of 5G network capabilities is related to intelligent transportation wherein data is shared between two or more vehicles (e.g., vehicle2vehicle communication, vehicle-to-vehicle communication, etc.) and/or data is shared between vehicles and a transportation infrastructure (e.g., vehicle2infrastructure communication, vehicle-to-infrastructure communication, etc.) to facilitate traffic management, autonomous driving, etc.

### SUMMARY

At least one example embodiment relates to an intelligent transportation system node.

In at least one example embodiment, the node may include a memory storing computer readable instructions and a plurality of input queues, the plurality of input queues including at least one first input queue associated with the node, and at least one second input queue associated with at least one preceding neighboring node, and processing circuitry configured to execute the computer readable instructions to cause the device to, determine traffic condition information associated with a desired segment of a road network, the road network including at least one reserved lane, determine whether to dequeue at least one access request token from the plurality of input queues based on the determined traffic condition information and vehicle information corresponding to at least one vehicle associated with the at least one access request token, and transmit at least one reserved lane access token from a set of reserved lane access tokens to at least one vehicle corresponding to the at least one dequeued access request token, the at least one reserved lane access token instructing the at least one vehicle to access to the reserved lane.

Some example embodiments provide that the vehicle information includes at least one of current position information corresponding to the at least one vehicle, current speed information corresponding to the at least one vehicle, current acceleration information corresponding to the at least one vehicle, vehicle type information corresponding to the at least one vehicle, occupancy information corresponding to the at least one vehicle, billing information corresponding to the at least one vehicle, destination information corresponding to the at least one vehicle, or any combinations thereof.

Some example embodiments provide that the node is further caused to, receive at least one first access request token from at least one first vehicle, the at least one first access request token including first vehicle information associated with the at least one first vehicle, and enqueue the at least one first access request token in the at least one first input queue associated with the node.

Some example embodiments provide that the node is further caused to, receive at least one output queue from the at least one preceding neighboring node, the at least one output queue including at least one second reserved lane access token corresponding to at least one second vehicle which received access to the reserved lane from the at least one preceding neighboring node, the at least one second reserved lane access token including at least one second vehicle information corresponding to the at least one second vehicle, enqueue the at least one second reserved lane access token in the at least one second input queue, and determine the traffic condition information associated with the desired segment of the road network based on the first vehicle information and the second vehicle information.

Some example embodiments provide that the at least one reserved lane access token and the at least one second lane access token each includes access expiration information associated with the corresponding vehicle, and the node is further caused to, determine whether to revoke access for the at least one vehicle based on the access expiration information associated with the at least one reserved lane access token corresponding to the at least one vehicle, the revoking access including dequeuing the respective reserved lane access token from the at least one first input queue, determine whether to revoke access for the at least one second vehicle based on the access expiration information associated with the at least one second reserved lane access token corresponding to the at least one second vehicle, the revoking access including dequeuing the respective reserved lane access token from the at least one second input queue, combine the at least one first input queue and the at least one second input queue into an output queue, and transmit the output queue to at least one succeeding neighboring node.

Some example embodiments provide that the node further includes at least one traffic camera configured to video record traffic conditions on the desired segment of the road network, and at least one traffic sensor configured to sense a number of vehicles travelling on the desired segment of the road network. The node may further be caused to, determine the traffic condition information associated with the desired segment of the road network based on the video recorded traffic conditions and the sensed number of vehicles.

Some example embodiments provide that the node is further caused to, receive preceding traffic condition information corresponding to at least one preceding segment of the road network from at least one preceding neighboring node, and determine the traffic condition information associated with the desired segment of the road network based on the preceding traffic condition information.

Some example embodiments provide that the node is further caused to, select the at least one access request token from the plurality of input queues to dequeue based on a dequeue policy, the dequeue policy being at least one of a first-come-first-served policy, a first-to-exit policy, a congestion-based queueing policy, and a priority-based queueing policy, and dequeue the selected at least one access request token.

Some example embodiments provide that the node is further caused to, determine a number of unallocated reserved lane access tokens in the set of reserved lane access tokens associated with the reserved lane, and determine whether to dequeue the at least one access request token from the plurality of input queues based on the determined number of unallocated reserved lane access tokens.

At least one example embodiment relates to a method of operating an intelligent transportation system node.

In at least one example embodiment, the method may include, determining traffic condition information associated with a desired segment of a road network, the road network including at least one reserved lane, determining whether to dequeue at least one access request token from a plurality of input queues based on the determined traffic condition information and vehicle information corresponding to at least one vehicle associated with the at least one access request token, the plurality of input queues including at least one first input queue associated with the node, and at least one second input queue associated with at least one preceding neighboring node, and transmitting at least one reserved lane access token from a set of reserved lane access tokens to at least one vehicle corresponding to the at least one dequeued access request token, the at least one reserved lane access token instructing the at least one vehicle to access to the reserved lane.

Some example embodiments provide that the vehicle information includes at least one of current position information corresponding to the at least one vehicle, current speed information corresponding to the at least one vehicle, current acceleration information corresponding to the at least one vehicle, vehicle type information corresponding to the at least one vehicle, occupancy information corresponding to the at least one vehicle, billing information corresponding to the at least one vehicle, destination information corresponding to the at least one vehicle, or any combinations thereof.

Some example embodiments provide that the method further includes, receiving at least one first access request token from at least one first vehicle, the at least one first access request token including first vehicle information associated with the at least one first vehicle, and enqueuing the at least one first access request token in the at least one first input queue associated with the node.

Some example embodiments provide that the method further includes, receiving at least one output queue from the at least one preceding neighboring node, the at least one output queue including at least one second reserved lane access token corresponding to at least one second vehicle which received access to the reserved lane from the at least one preceding neighboring node, the at least one second reserved lane access token including at least one second vehicle information corresponding to the at least one second vehicle, enqueuing the at least one second reserved lane access token in the at least one second input queue, and determining the traffic condition information associated with the desired segment of the road network based on the first vehicle information and the second vehicle information.

Some example embodiments provide that the at least one reserved lane access token and the at least one second lane access token each includes access expiration information associated with the corresponding vehicle, and the method further includes, determining whether to revoke access for the at least one vehicle based on the access expiration information associated with the at least one reserved lane access token corresponding to the at least one vehicle, the revoking access including dequeuing the respective reserved lane access token from the at least one first input queue, determining whether to revoke access for the at least one second vehicle based on the access expiration information associated with the at least one second reserved lane access token corresponding to the at least one second vehicle, the revoking access including dequeuing the respective reserved lane access token from the at least one second input queue, combining the at least one first input queue and the at least one second input queue into an output queue, and transmitting the output queue to at least one succeeding neighboring node.

Some example embodiments provide that the method further includes, video recording, using at least one traffic camera, traffic conditions on the desired segment of the road network, video recording, using at least one traffic camera, traffic conditions on the desired segment of the road network, and determining the traffic condition information associated with the desired segment of the road network based on the video recorded traffic conditions and the sensed number of vehicles.

Some example embodiments provide that the method further includes, receiving preceding traffic condition information corresponding to at least one preceding segment of the road network from at least one preceding neighboring node, and determining the traffic condition information associated with the desired segment of the road network based on the preceding traffic condition information.

Some example embodiments provide that the method further includes, selecting the at least one access request token from the plurality of input queues to dequeue based on a dequeue policy, the dequeue policy being at least one of a first-come-first-served policy, a first-to-exit policy, a congestion-based queueing policy, and a priority-based queueing policy, and dequeuing the selected at least one access request token.

Some example embodiments provide that the method further includes, determining a number of unallocated reserved lane access tokens in the set of reserved lane access tokens associated with the reserved lane, and determining whether to dequeue the at least one access request token from the plurality of input queues based on the determined number of unallocated reserved lane access tokens.

At least one example embodiment relates to a vehicle.

In at least one example embodiment, the vehicle may include a memory storing computer readable instructions, and processing circuitry configured to execute the computer readable instructions to cause the vehicle to, transmit an access request token to at least one intelligent transportation system node, the access request token including vehicle information, the vehicle information including at least one of current position information corresponding to the vehicle, current speed information corresponding to the vehicle, current acceleration information corresponding to the vehicle, vehicle type information corresponding to the vehicle, occupancy information corresponding to the vehicle, billing information corresponding to the vehicle, destination information corresponding to the vehicle, or any combinations thereof, and receive at least one reserved lane access token from the node in response to the access request token, the at least one reserved lane access token instructing the vehicle to access to the reserved lane.

Some example embodiments provide that the vehicle is an autonomous vehicle, the reserved lane access token includes at least one of a permitted amount of travel time on the reserved lane, a permitted travel distance on the reserved lane, or a combination thereof, and the vehicle is further caused to autonomously drive on the reserved lane based on the at least one reserved lane access token.

At least one example embodiment relates to an intelligent transportation system node.

In at least one example embodiment, the vehicle may include means for, storing computer readable instructions and a plurality of input queues, the plurality of input queues including at least one first input queue associated with the node, and at least one second input queue associated with at least one preceding neighboring node, determining traffic condition information associated with a desired segment of a road network, the road network including at least one reserved lane, determining whether to dequeue at least one access request token from the plurality of input queues based on the determined traffic condition information and vehicle information corresponding to at least one vehicle associated with the at least one access request token, and transmitting at least one reserved lane access token from a set of reserved lane access tokens to at least one vehicle corresponding to the at least one dequeued access request token, the at least one reserved lane access token instructing the at least one vehicle to access to the reserved lane.

Some example embodiments provide that the vehicle information includes at least one of current position information corresponding to the at least one vehicle, current speed information corresponding to the at least one vehicle, current acceleration information corresponding to the at least one vehicle, vehicle type information corresponding to the at least one vehicle, occupancy information corresponding to the at least one vehicle, billing information corresponding to the at least one vehicle, destination information corresponding to the at least one vehicle, or any combinations thereof.

Some example embodiments provide that the node further includes means for, receiving at least one first access request token from at least one first vehicle, the at least one first access request token including first vehicle information associated with the at least one first vehicle, and enqueuing the at least one first access request token in the at least one first input queue associated with the node.

Some example embodiments provide that the node further includes means for, receiving at least one output queue from the at least one preceding neighboring node, the at least one output queue including at least one second reserved lane access token corresponding to at least one second vehicle which received access to the reserved lane from the at least one preceding neighboring node, the at least one second reserved lane access token including at least one second vehicle information corresponding to the at least one second vehicle, enqueuing the at least one second reserved lane access token in the at least one second input queue, and determining the traffic condition information associated with the desired segment of the road network based on the first vehicle information and the second vehicle information.

Some example embodiments provide that the at least one reserved lane access token and the at least one second lane access token each includes access expiration information associated with the corresponding vehicle, and the node further includes means for, determining whether to revoke access for the at least one vehicle based on the access expiration information associated with the at least one reserved lane access token corresponding to the at least one vehicle, the revoking access including dequeuing the respective reserved lane access token from the at least one first input queue, determining whether to revoke access for the at least one second vehicle based on the access expiration information associated with the at least one second reserved lane access token corresponding to the at least one second vehicle, the revoking access including dequeuing the respective reserved lane access token from the at least one second input queue, combining the at least one first input queue and the at least one second input queue into an output queue, and transmitting the output queue to at least one succeeding neighboring node.

Some example embodiments provide that the node further includes means for, video recording traffic conditions on the desired segment of the road network, sensing a number of vehicles travelling on the desired segment of the road network, and determining the traffic condition information associated with the desired segment of the road network based on the video recorded traffic conditions and the sensed number of vehicles.

Some example embodiments provide that the node further includes means for, receiving preceding traffic condition information corresponding to at least one preceding segment of the road network from at least one preceding neighboring node, and determining the traffic condition information associated with the desired segment of the road network based on the preceding traffic condition information.

Some example embodiments provide that the node further includes means for, selecting the at least one access request token from the plurality of input queues to dequeue based on a dequeue policy, the dequeue policy being at least one of a first-come-first-served policy, a first-to-exit policy, a congestion-based queueing policy, and a priority-based queueing policy, and dequeuing the selected at least one access request token.

Some example embodiments provide that the node further includes means for, determining a number of unallocated reserved lane access tokens in the set of reserved lane access tokens associated with the reserved lane, and determining whether to dequeue the at least one access request token from the plurality of input queues based on the determined number of unallocated reserved lane access tokens.

At least one example embodiment relates to a vehicle.

In at least one example embodiment, the vehicle may include means for, transmitting an access request token to at least one intelligent transportation system node, the access request token including vehicle information, the vehicle information including at least one of current position information corresponding to the vehicle, current speed information corresponding to the vehicle, current acceleration information corresponding to the vehicle, vehicle type information corresponding to the vehicle, occupancy information corresponding to the vehicle, billing information corresponding to the vehicle, destination information corresponding to the vehicle, or any combinations thereof, and receiving at least one reserved lane access token from the node in response to the access request token, the at least one reserved lane access token instructing the vehicle to access to the reserved lane.

Some example embodiments provide that the vehicle is an autonomous vehicle, the reserved lane access token includes at least one of a permitted amount of travel time on the reserved lane, a permitted travel distance on the reserved lane, or a combination thereof, and the vehicle further includes means for autonomously driving on the reserved lane based on the at least one reserved lane access token.

### BRIEF DESCRIPTION OF THE DRAWINGS

The accompanying drawings, which are incorporated in and constitute a part of the specification, illustrate one or more example embodiments and, together with the description, explain these example embodiments. In the drawings:

FIG. 1A illustrates an example intelligent transportation system (ITS) road segment according to at least one example embodiment;

FIG. 1B illustrates example ITS communication network diagram according to at least one example embodiment;

FIG. 2 illustrates a block diagram of an example ITS node according to at least one example embodiment;

FIG. 3 illustrates a block diagram of an example ITS-compatible vehicle according to at least one example embodiment;

FIG. 4 illustrates a functional block diagram of example processing circuitry of an ITS-compatible vehicle according to at least one example embodiment; and

FIG. 5 illustrate an example flowchart for operating an ITS node according to at least one example embodiment.

### DETAILED DESCRIPTION

Various example embodiments will now be described more fully with reference to the accompanying drawings in which some example embodiments are shown.

Detailed example embodiments are disclosed herein. However, specific structural and functional details disclosed herein are merely representative for purposes of describing the example embodiments. The example embodiments may, however, be embodied in many alternate forms and should not be construed as limited to only the example embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the example embodiments. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of the example embodiments. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of the example embodiments. However, it will be understood by one of ordinary skill in the art that example embodiments may be practiced without these specific details. For example, systems may be shown in block diagrams in order not to obscure the example embodiments in unnecessary detail. In other instances, well-known processes, structures and techniques may be shown without unnecessary detail in order to avoid obscuring example embodiments.

Also, it is noted that example embodiments may be described as a process depicted as a flowchart, a flow diagram, a data flow diagram, a structure diagram, or a block diagram. Although a flowchart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, a function, a procedure, a subroutine, a subprogram, etc. When a process corresponds to a function, its termination may correspond to a return of the function to the calling function or the main function.

Moreover, as disclosed herein, the term “memory” may represent one or more devices for storing data, including random access memory (RAM), magnetic RAM, core memory, and/or other machine readable mediums for storing information. The term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” may include, but is not limited to, portable or fixed storage devices, optical storage devices, wireless channels, and various other mediums capable of storing, containing or carrying instruction(s) and/or data.

Furthermore, example embodiments may be implemented by hardware circuitry and/or software, firmware, middleware, microcode, hardware description languages, etc., in combination with hardware (e.g., software executed by hardware, etc.). When implemented in software, firmware, middleware or microcode, the program code or code segments to perform the desired tasks may be stored in a machine or computer readable medium such as a non-transitory computer storage medium, and loaded onto one or more processors to perform the desired tasks.

A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

As used in this application, the term “circuitry” and/or “hardware circuitry” may refer to one or more or all of the following: (a) hardware-only circuit implementation (such as implementations in only analog and/or digital circuitry); (b) combinations of hardware circuits and software, such as (as applicable): (i) a combination of analog and/or digital hardware circuit(s) with software/firmware, and (ii) any portions of hardware processor(s) with software (including digital signal processor(s)), software, and memory(ies) that work together to cause an apparatus, such as a mobile phone or server, to perform various functions); and (c) hardware circuit(s) and/or processor(s), such as microprocessor(s) or a portion of a microprocessor(s), that requires software (e.g., firmware) for operation, but the software may not be present when it is not needed for operation. For example, the circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

While the various example embodiments of the present disclosure are discussed in connection with the 5G wireless communication standard for the sake of clarity and convenience, the example embodiments are not limited thereto, and one of ordinary skill in the art would recognize the example embodiments may be applicable to other wireless communication standards, such as the 4G standard, a Wi-Fi standard, a future 6G standard, a future 7G standard, etc.

Various example embodiments are directed towards a connected vehicle corridor and/or connected road segment for use in an intelligent vehicle transportation system (ITS). One or more example embodiments of the connected vehicle corridor of the ITS reduce and/or decrease transit congestion by increasing and/or maximizing the number of passengers transported over a desired time period (e.g., an hour, a day, a week, etc.) through the associated connected vehicle corridor using traffic information obtained by at least one ITS node via vehicle-to-infrastructure (V2I) communication and/or infrastructure-to-infrastructure (I2I) communication, etc. Additionally, at least one example embodiment of the connected vehicle corridor may improve vehicle safety and/or traffic congestion by improving and/or optimizing the number and allocation of vehicles in designated lanes of the connected vehicle corridor based on traffic information and/or vehicle information, etc. Moreover, at least one example embodiment may further provide centralized control of autonomous vehicles based on the traffic information and/or vehicle information through the ITS nodes, thereby further improving the safety, speed, and/or reliability of autonomous vehicles, etc.

Additionally, while the example embodiments are discussed in connection with an automobile based intelligent transportation system (ITS), the example embodiments are not limited thereto, and for example, one or more aspects of the example embodiments may be applied to controlling robot movement and/or robot traffic in a warehouse facility, shipping container logistics in a port/harbor facility, aircraft traffic at an airport, etc.

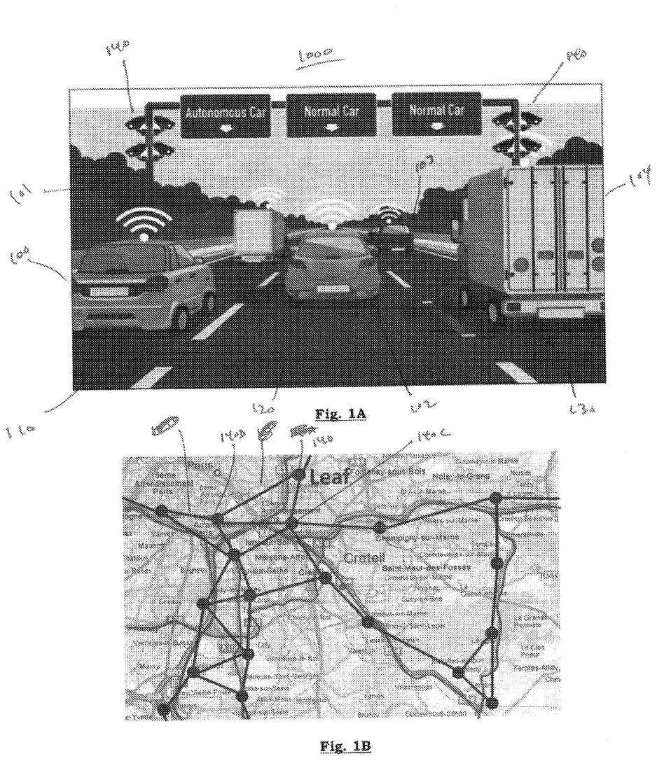

FIG. 1A illustrates an example intelligent transportation system (ITS) road segment according to at least one example embodiment, and FIG. 1B illustrates example ITS communication network diagram according to at least one example embodiment.

As shown in FIG. 1A, an ITS connected corridor and/or road segment 1000 may be a corridor, segment, section, and/or partition of a road, but is not limited thereto, and for example, may be segments of airport runways, segments of a warehouse, segments of a harbor facility, etc. As shown in FIG. 1A, the connected corridor may include a plurality of lanes, such as lanes 110, 120, and/or 130, etc., but the example embodiments are not limited thereto. The plurality of lanes may include at least one reserved access lane, e.g., lane 110, and at least one normal and/or regular lane, e.g., lanes 120 and 130, etc., but the example embodiments are not limited thereto, and for example, there may be a greater or lesser number of regular lanes and/or a greater number of reserved access lanes, etc. The reserved access lane 110 may be reserved for vehicles which have been registered with an ITS service, such as being a member and/or subscriber to the ITS service, paying a toll to access the ITS service, etc., and/or unregistered vehicles which meet desired vehicular conditions for access to the reserved lane, such as a high occupancy vehicle condition, a reduced carbon emission condition, an autonomous vehicle condition, a vehicle type condition (e.g., emergency vehicles, road construction-related vehicles, taxi, ride sharing vehicles, commercial vehicles, bus, motorcycle, make and model information of the vehicle, etc.), etc., but the example embodiments are not limited thereto. For example, the ITS service may grant access to the at least one reserved access lane 110 to vehicles based on desired traffic metrics (and/or desired traffic conditions, etc.), such as a desired passenger throughput metric for the connected corridor 1000, a desired average vehicle speed metric, etc., to improve the flow of traffic along the connected corridor 1000, etc.

Moreover, the ITS service may grant access to the at least one reserved access lane 110 to vehicles based on real-time and/or dynamic traffic conditions experienced on the ITS connected corridor and/or real-time and/or dynamic traffic conditions experienced on at least one other ITS connected corridor, such as a future ITS connected corridor (e.g., a later, succeeding, and/or downstream ITS connected corridor based on the direction of travel of the road) and/or a previous ITS connected corridor (e.g., an earlier, preceding, and/or upstream ITS connected corridor based on the direction of travel of the road), etc. For example, if a future ITS connected corridor (e.g., corridor 1010 of FIG. 1B) reports that there has been a traffic accident on one of its normal lanes, the ITS service may direct one or more vehicles to preemptively use the reserved access lane 110 on the ITS connected corridor 1000 in order to avoid, decrease, and/or minimize traffic slow down and/or congestion at the ITS connected corridor 1010, etc., but the example embodiments are not limited thereto.

Additionally, the ITS connected corridor 1000 may further include at least one ITS node 140, but is not limited thereto. The ITS node 140 is a network node for controlling, supervising, and/or managing the allocation of vehicles to the at least one reserved access lane 110, for monitoring real-time and/or dynamic traffic conditions of the plurality of lanes of the connected corridor 1000, and/or for transmitting and/or receiving traffic information and/or traffic instructions to/from one or more vehicles traveling on the connected corridor 1000, etc. According to some example embodiments, the ITS node 140 may act as a radio access network (RAN) node and may be connected over a wireless network, such as a cellular wireless access network (e.g., a 3G wireless access network, a 4G-Long Term Evolution (LTE) network, a 5G-New Radio (e.g., 5G) wireless network, a 6G wireless network, a WiFi network, etc.). The wireless network may include a core network associated with and/or corresponding to the ITS network (not shown) and/or a Data Network (not shown). The ITS node 140 may connect to other ITS nodes, such as ITS nodes 140B, and 140C, etc., of FIG. 1B, other RAN nodes, such as 5G RAN nodes (not shown), as well as to the core network and/or the Data Network, over a wired and/or wireless network. The core network may refer to an internal network dedicated to the ITS system, etc., and the Data Network may refer to the Internet, an intranet, a wide area network, etc., but the example embodiments are not limited thereto.

According to some example embodiments, the ITS node 140 may communicate with at least one vehicle, such as vehicles 100, 101, 102, 103, and/or 104, etc., and/or may communicate with one or more user equipment (UE) devices (not shown), etc. In some example embodiments, the ITS node 140 may act as a relay node and may relay instructions and/or information received from a central ITS server (not shown) and/or another ITS node to neighboring ITS nodes, e.g., ITS node 140B and/or ITS node 140C, etc., and/or to one or more vehicles (and/or UE devices included in the one or more vehicles) within transmission range of the ITS node 140, etc. Further, the ITS node 140 may receive requests, data (e.g., traffic condition information, vehicle information, etc.) from at least one vehicle, e.g., vehicles 100, 101, 102, 103, and/or 104, etc., traveling within transmission range of the ITS node 140, etc. Additionally, the ITS node 140 may perform one or more of the above communications in combination with at least one base station (and/or access point (AP), router, etc.) (not shown) of the same or a different radio access technology (e.g., WiFi, etc.).

The vehicles and/or UE devices may be any one of, but not limited to, an automobile, an autonomous automobile, a motorcycle, a commercial truck, an emergency vehicle (e.g., an ambulance, a fire emergency vehicle, a police vehicle, etc.), a mobile device, a navigation device, a vehicle infotainment device, a smartphone, a tablet, a desktop computer, a laptop computer, a wearable device, an Internet of Things (IOT) device, sensors (e.g., traffic flow sensors, pressure sensors, motion sensors, accelerometers, etc.), actuators, robotic devices, drones, connected medical devices, eHealth devices, smart city related devices, a security camera, and/or any other type of stationary or portable device capable of operating according to, for example, the 5G NR communication standard, and/or other wireless communication standard(s). The vehicles 100 to 104, etc., may be configurable to transmit and/or receive data in accordance to strict latency, reliability, and/or accuracy requirements, such as URLLC communications, TSC communications, etc., but the example embodiments are not limited thereto.

The ITS system may further include a plurality of transmission/reception points (TRPs), e.g., a base station, a wireless access point, radio relays, etc., (not shown), installed at one or more locations along and/or proximate to a road network associated with and/or corresponding to the ITS system, but is not limited thereto. Additionally, the ITS nodes 140, 140B, 140C, etc., may operate according to an underlying cellular and/or wireless radio access technology (RAT), such as 5G NR, LTE, Wi-Fi, etc. For example, the ITS nodes 140, 140B, 140C, etc., may be a 5G gNB node, a LTE eNB node, or a LTE ng-eNB node, etc., but the example embodiments are not limited thereto. The ITS nodes 140, 140B, 140C, etc. may provide ITS services and/or wireless network services to one or more vehicles and/or UE devices within one or more cells (e.g., cell service areas, broadcast areas, serving areas, coverage areas, etc.) surrounding the respective physical location of the ITS node.

Additionally, the ITS nodes 140, 140B, 140C, etc., may be configured to operate in a multi-user (MU) multiple input multiple out (MIMO) mode and/or a massive MIMO (mMIMO) mode, wherein the ITS nodes 140, 140B, 140C, etc., transmit a plurality of beams (e.g., radio channels, datastreams, streams, etc.) in different spatial domains and/or frequency domains using a plurality of antennas (e.g., antenna panels, antenna elements, an antenna array, etc.) and beamforming and/or beamsteering techniques. For example, ITS nodes 140, 140B, and/or 140C, etc., may each transmit and/or receive transmissions using two or more beams, but the example embodiments are not limited thereto, and for example, one or more of the ITS nodes may transmit using a greater or lesser number of beams, etc.

Further, the ITS nodes 140, 140B, 140C, etc., may include at least one sensor (e.g., traffic sensor, traffic camera, etc.) to determine real-time and/or dynamic traffic conditions on the respective road segment and/or individual lanes of the respective road segments. For example, the ITS node 140 may further include at least one camera to visually determine the number, geographical position (e.g., location), speed, rate of acceleration, vehicle type, number of passengers, and/or identity of vehicles, etc., traveling on the road segment and/or individual lanes of the road segment, but is not limited thereto. According to some example embodiments, the ITS nodes 140, 140B, 140C, etc., may employ known computer vision techniques and/or trained machine learning algorithms, etc., to detect the number, geographical position (e.g., location), speed, rate of acceleration, vehicle type, number of passengers, and/or identity of vehicles, etc., using the video footage from the at least one camera, but the example embodiments are not limited thereto. Further, the ITS node 140 may also include additional sensors, such as radio frequency identification (RFID) sensors, Bluetooth Low Energy (BLE) sensors, WiFi sensors, etc., laser sensors, pressure sensors, etc., to sense the number, geographical position, speed, rate of acceleration, vehicle type, number of passengers, and/or identity of vehicles traveling on the road segment and/or individual lanes of the road segment, etc.

Referring now to FIG. 1B, the ITS communication network system may include a plurality of ITS nodes, such as ITS nodes 140, 140B, 140C, etc., but the example embodiments are not limited thereto. The ITS nodes 140, 140B, 140C, etc., may be located proximate to a desired ITS road segment, but re not limited thereto, and for example, the ITS node components may be distributed, wherein one or more sensors associated with the ITS node is proximate to and/or adjacent to the desired road segment, and RAN components associated with the ITS node are located in relatively geographically distant locations from the desired ITS road segment, but the example embodiments are not limited thereto.

According to some example embodiments, the ITS network functions as an undirected graph, with each ITS node acting as an edge node of the undirected graph, and wherein each ITS node manages a sub-graph of its direct neighbors' nodes (e.g., the neighboring ITS nodes, etc.). In other words, each ITS node manages at least one desired road segment and/or connected corridor of a physical road network as shown in FIG. 1B, but the example embodiments not limited thereto. Moreover, according to some example embodiments, a first ITS node, e.g., ITS node 140, may be located a desired distance away from each of its neighboring ITS nodes, e.g., ITS nodes 140B and/or 140C may be approximately 1 to 20 km away from ITS node 140, to facilitate and/or ensure that the latency of communication between the ITS nodes correspond to a desired latency value, e.g., approximately 5 μs, etc., but the example embodiments are not limited thereto, and the desired distance between ITS nodes and/or the desired latency value may change depending upon the average bandwidth of communication between the ITS nodes, environmental factors impacting communication speeds, and/or geographical considerations with respect to the proximity of the ITS nodes to their respective road segments, etc.

While certain components of an ITS road segment of FIG. 1A and an ITS communication network diagram of FIG. 1B are shown, the example embodiments are not limited thereto, and the ITS road segment and/or the ITS communication network diagram may include components other than that shown in FIGS. 1A and 1B, which are desired, necessary, and/or beneficial for operation of the underlying networks within the ITS and/or wireless communication system, such as access points, switches, routers, nodes, servers, gateways, etc.

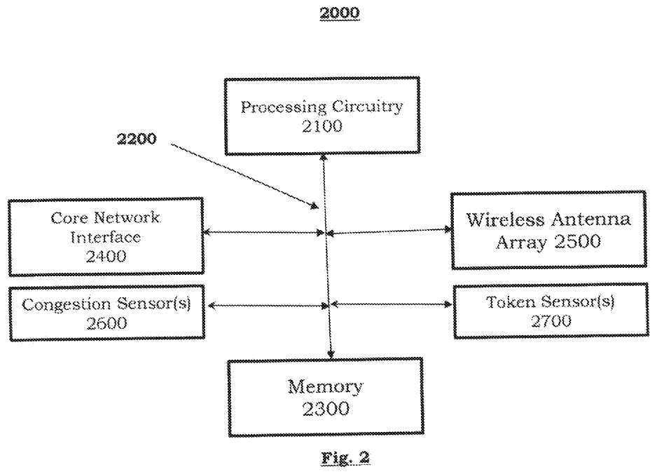

FIG. 2 illustrates a block diagram of an example ITS node according to at least one example embodiment. The ITS node of FIG. 2 may correspond to the ITS nodes 140, 140B, and/or 140C of FIGS. 1A and 1B, but the example embodiments are not limited thereto.

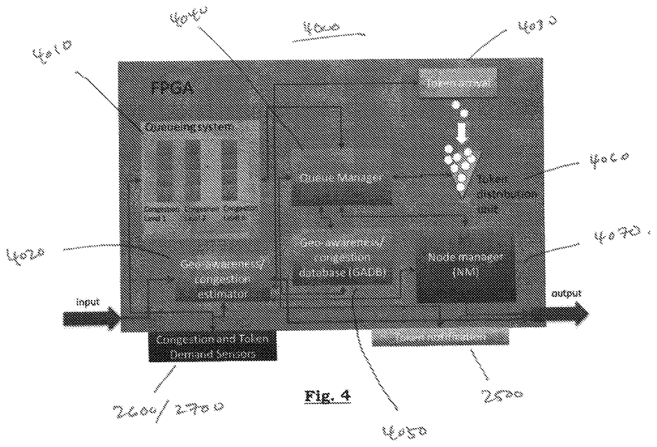

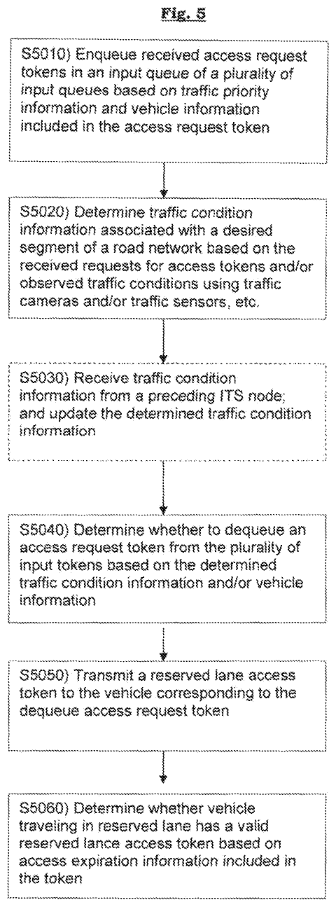

Referring to FIG. 2, an ITS node 2000 may include processing circuitry, such as at least one processor 2100, at least one communication bus 2200, a memory 2300, at least one core network interface 2400 (e.g., an ITS network interface, etc.), at least one wireless antenna array 2500, at least one traffic congestion sensor 2600, and/or at least one token sensor 2700, etc., but the example embodiments are not limited thereto. For example, the core network interface 2400 and the wireless antenna array 2500 may be combined into a single network interface, etc., or the ITS node 2000 may include a plurality of wireless antenna arrays, a plurality of core network interfaces, etc., and/or any combinations thereof. The memory 2300 may include various special purpose program code including computer executable instructions for performing the operations of FIGS. 4-5, etc., which may cause the ITS node 2000 to perform the one or more of the methods of the example embodiments, but the example embodiments are not limited thereto.

In at least one example embodiment, the processing circuitry may include at least one processor (and/or processor cores, distributed processors, networked processors, etc.), such as the at least one processor 2100, which may be configured to control one or more elements of the ITS node 2000, and thereby cause the ITS node 2000 to perform various operations. The processing circuitry (e.g., the at least one processor 2100, etc.) is configured to execute processes by retrieving program code (e.g., computer readable instructions) and data from the memory 2300 to process them, thereby executing special purpose control and functions of the entire ITS node 2000. Once the special purpose program instructions are loaded into, (e.g., the at least one processor 2100, etc.), the at least one processor 2100 executes the special purpose program instructions, thereby transforming the at least one processor 2100 into a special purpose processor. According to some example embodiments, the at least one processor 2100 may include a specially programmed FPGA, a special purpose SoC, a special purpose ASIC, etc., which is specifically provided to perform the functionality related to the ITS service and/or management of the reserved lane of the connected corridor, etc., but the example embodiments are not limited thereto.

In at least one example embodiment, the memory 2300 may be a non-transitory computer-readable storage medium and may include a random access memory (RAM), a read only memory (ROM), and/or a permanent mass storage device such as a disk drive, or a solid state drive. Stored in the memory 2300 is program code (i.e., computer readable instructions) related to operating the ITS node 2000, such as the methods discussed in connection with FIG. 5, the at least one core network interface 2400, at least one wireless antenna array 2500, at least one traffic congestion sensor 2600, and/or at least one token sensor 2700, etc. Such software elements may be loaded from a non-transitory computer-readable storage medium independent of the memory 2300, using a drive mechanism (not shown) connected to the ITS node 2000, or via the at least one core network interface 2400, and/or at least one wireless antenna array 2500, etc.

Additionally, the memory 2300 may further store one or more input queues associated with the vehicle access requests for the reserved lane corresponding to the desired road segment, one or more output queues associated with tokens (e.g., reserved lane access tokens, etc.) with the desired road segment, priority lookup tables (LUTs) storing priority rules associated with the ITS service, queue management rules, and/or access rules associated with the reserved lane of the desired road segment, etc., which the ITS node 2000 may use to manage ITS service and/or access to the reserved lane of the desired road segment, but the example embodiments are not limited thereto. The at least one input queue, at least one output queue, and the priority LUTs will be discussed in further detail in connection with FIGS. 4-5.

In at least one example embodiment, the communication bus 2200 may enable communication and data transmission to be performed between elements of the ITS node 2000. The bus 2200 may be implemented using a high-speed serial bus, a parallel bus, and/or any other appropriate communication technology. According to at least one example embodiment, the ITS node 2000 may include a plurality of communication buses (not shown), such as an address bus, a data bus, etc.

Additionally, according to some example embodiments, the ITS node 2000 may also operate as a RAN node, for example, a 4G RAN node, a 5G RAN node, etc., for vehicles traveling on the connected corridor and/or road segment, and/or any UE devices included in the vehicles and/or operated by passengers of the vehicles, e.g., smartphones operated by the passengers, etc., but the example embodiments are not limited thereto.

The ITS node 2000 may also include at least one core network interface 2400, and/or at least one wireless antenna array 2500, etc. The at least one wireless antenna array 2500 may include an associated array of radio units (not shown) and may be used to transmit the wireless signals in accordance with a radio access technology, such as 4G LTE wireless signals, 5G NR wireless signals, RFID wireless signals, Bluetooth wireless signals, WiFi wireless signals, etc., to at least one vehicle and/or UE device, such as vehicles 100 to 104, etc. According to some example embodiments, the wireless antenna array 2500 may be a single antenna, or may be a plurality of antennas, etc. For example, the wireless antenna array 2500 may be configured as a grid of beams (GoB) which transmits a plurality of beams in different directions, angles, frequencies, and/or with different delays, etc., but the example embodiments are not limited thereto.

The ITS node 2000 may communicate with a core network (e.g., an ITS backend network, backhaul network, backbone network, Data Network, etc.) of the ITS communication network via the core network interface 2400. The core network interface 2400 may be a wired and/or wireless network interface and may enable the ITS node 2000 to communicate and/or transmit data to and/or from network devices on the backend network, such as a neighboring ITS nodes, a central ITS management server (not shown), a core network gateway (not shown), a Data Network, such as the Internet, intranets, wide area networks, etc.

In at least one example embodiment, the ITS node 2000 may include at least one traffic congestion sensor 2600 (e.g., at least one congestion sensor, etc.) and/or at least one token sensor 2700, but the example embodiments are not limited thereto, and for example, the traffic congestion sensor 2600 and the token sensor 2700 may be combined into a single entity and/or one or more of the traffic congestion sensor 2600 and the token sensor 2700 may be combined with the wireless antenna array 2500 and/or the processing circuitry 2100, etc. According to some example embodiments, the congestion sensor 2600 may be at least one camera to visually determine the number, geographical position, speed, rate of acceleration, vehicle type, number of passengers, and/or identity of vehicles (e.g., identify the license plate number, unique identifier, IP address and/or MAC address, etc., of the vehicle), etc., traveling on the road segment and/or individual lanes of the road segment, but is not limited thereto. Further, the ITS node 140 may also include additional congestion sensors, such as laser sensors, infrared sensors, pressure sensors, etc., to sense the number, geographical position, speed, rate of acceleration, vehicle type, number of passengers, and/or identity of vehicles (e.g., a unique ITS subscriber identification number, etc.) traveling on the road segment and/or individual lanes of the road segment, etc.

Additionally, the ITS node 140 may include at least one token sensor 2700, such as a RFID sensor, a Bluetooth sensor, etc., which may communicate with a wireless transponder (e.g., electronic tag, etc.) installed on the vehicle, but the example embodiments are not limited thereto. The ITS node 140 may receive requests for access to the reserved lane of the ITS connected corridor and/or road segment from, e.g., vehicle 100, etc., through the at least one token sensor 2700, and/or the ITS node 140 may transmit reserved lane access tokens (e.g., tokens, authorization grants, etc.) to the vehicle 100 using the at least one token sensor 2700, etc., but the example embodiments are not limited thereto. Further, the ITS node 140 and the vehicle 100 may communicate traffic congestion information (and/or traffic condition information, etc.) to the other via the token sensor 2700 and transponder, and the vehicle 100 may transmit authorization information, ITS subscriber information, vehicle information (e.g., current speed, current rate of acceleration, current number of occupants, vehicle type information, etc.), and/or billing information for ITS services through a transponder and the token sensor 2700, etc., but the example embodiments are not limited thereto.

In some example embodiments, the ITS node 140 may also determine and/or infer traffic congestion information from vehicle information obtained directly from one or more vehicles traveling on the desired road segment, such as travel destination information, vehicle occupancy information, vehicle speed information, vehicle change in acceleration information, etc. For example, if the ITS node 140 receives multiple transmissions of sudden deceleration performed by multiple vehicles and/or multiple transmissions reporting low vehicle speed, the ITS node 140 may infer that there is traffic congestion present in the connected corridor and/or road segment, etc. Further, if the ITS node 140 receives multiple transmissions from vehicles indicating the same and/or similar destination, the ITS node 140 may infer that there will be traffic congestion and/or increased traffic between the road segments corresponding to the ITS node 140 and the road segment corresponding to the destination location, etc. As an example, if multiple vehicles have transmitted that their destinations are the same sports stadium, concert venue, etc., the ITS node 140 may infer that the highway exits proximate to the shared destination and/or local roads surrounding the shared destination will experience traffic congestion, etc., but the example embodiments are not limited thereto.

Moreover, in some example embodiments, the ITS node 140 may also transmit control information (e.g., driving commands, driving instructions, etc.) to autonomous vehicles traveling in the reserved lane and/or along the road segment and/or connected corridor, etc., based on the determined traffic congestion information, but is not limited thereto. For example, the ITS node 140 may transmit control information to the autonomous vehicles indicating a desired travel speed for the autonomous vehicles, setting a desired travel distance between autonomous vehicles, setting lane assignments, managing lane changes, etc., but the example embodiments are not limited thereto. The functionality of the ITS node 140 will be discussed in greater detail in connection with FIGS. 4-5.

The example embodiments are not limited thereto, and in some example embodiments the token sensor 2700 may be optional and may be omitted, and the communication between the ITS node 140 and the vehicle 100 may be performed using the wireless antenna array 2500 instead, etc.

While FIG. 2 depicts an example embodiment of an ITS node 2000, the ITS nodes are not limited thereto, and may include additional and/or alternative architectures that may be suitable for the purposes demonstrated.

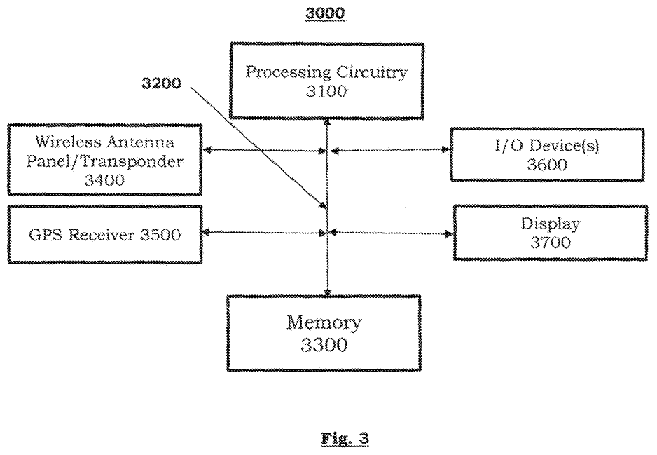

FIG. 3 illustrates a block diagram of an example vehicle according to at least one example embodiment. The example vehicle 3000 of FIG. 3 may correspond to the vehicles 100, 101, 102, 103, and/or 104 of FIG. 1A, but the example embodiments are not limited thereto, and the vehicles may employ alternative architectures, etc.

Referring to FIG. 3, a vehicle 3000 (e.g., a connected vehicle, an intelligent vehicle, an autonomous vehicle, a connected non-autonomous vehicle, etc.) may include processing circuitry, such as at least one processor 3100, at least one communication bus 3200, a memory 3300, a plurality of wireless antennas and/or wireless antenna panels 3400, at least one geolocation sensor 3500 (e.g., GPS receiver, GLONASS receiver, Beidou receiver, Galileo receiver, etc.), at least one input/output (I/O) device 3600 (e.g., a touchscreen, a microphone, a camera, a keyboard, a mouse, a camera, a speaker, etc.), and/or a display panel 3700 (e.g., a console display, a heads up display, a touchscreen, etc.), but the example embodiments are not limited thereto. According to some example embodiments, the vehicle 3000 may include a greater or lesser number of constituent components, and for example, the vehicle 3000 may also include at least one battery (not shown), one or more proximity sensors (e.g., an infra-red proximity sensor, a radar sensor, a LIDAR sensor, etc.), other sensors (e.g., thermometers, humidity sensors, pressure sensors, motion sensors, accelerometers, etc.), autonomous driving controls (e.g., actuators, computer vision cameras, etc.), but the example embodiments are not limited thereto. Additionally, the display panel 3700, and/or I/O device 3600, etc., of the vehicle 3000 may be optional.

In at least one example embodiment, the processing circuitry may include at least one processor (and/or processor cores, distributed processors, networked processors, etc.), such as the at least one processor 3100, which may be configured to control one or more elements of the vehicle 3000, and thereby cause the vehicle 3000 to perform various operations, such as the operations discussed in connection with FIGS. 4-5, operations related to autonomous driving of the vehicle, etc. The processing circuitry (e.g., the at least one processor 3100, etc.) is configured to execute processes by retrieving program code (e.g., computer readable instructions) and data from the memory 3300 to process them, thereby executing special purpose control and functions of the entire vehicle 3000. Once the special purpose program instructions are loaded into the processing circuitry (e.g., the at least one processor 3100, etc.), the at least one processor 3100 executes the special purpose program instructions, thereby transforming the at least one processor 3100 into a special purpose processor. According to some example embodiments, the at least one processor 3100 may include a specially programmed FPGA, a special purpose SoC, a special purpose ASIC, etc., which is specifically provided to perform the functionality related to the ITS service and/or request for access to the reserved lane of the connected corridor, etc., but the example embodiments are not limited thereto. The special purpose FPGA/SoC/ASIC, etc., may be separate from the at least one processor 3100 and/or may be added to the vehicle 3000 post-purchase, e.g., as an add-on component, executed using special purpose software installed on a vehicle owner's smartphone, etc.

In at least one example embodiment, the memory 3300 may be a non-transitory computer-readable storage medium and may include a random access memory (RAM), a read only memory (ROM), and/or a permanent mass storage device such as a disk drive, or a solid state drive. Stored in the memory 3300 is program code (i.e., computer readable instructions) related to operating the vehicle 3000, such as the methods discussed in connection with FIGS. 4 to 5, autonomous driving and/or operation of the vehicle 3000, etc. Such software elements may be loaded from a non-transitory computer-readable storage medium independent of the memory 3300, using a drive mechanism (not shown) connected to the vehicle 3000, or via the plurality of wireless antennas 3400, etc. Additionally, the memory 3300 may store ITS subscriber information, such as system information, billing information, token information, vehicle information, etc., for communicating with at least one ITS node, e.g., ITS node 140, etc., but the example embodiments are not limited thereto.

In at least one example embodiment, the at least one communication bus 3200 may enable communication and data transmission/reception to be performed between elements of the vehicle 3000, and/or monitor the status of the elements of the vehicle 3000, etc. The bus 3200 may be implemented using a high-speed serial bus, a parallel bus, and/or any other appropriate communication technology. According to at least one example embodiment, the vehicle 3000 may include a plurality of communication buses (not shown), such as an address bus, a data bus, etc.

The vehicle 3000 may also include a plurality of wireless antenna panels 3400, but is not limited thereto. The plurality of wireless antenna panels 3400 may include a plurality of associated radio units, etc., and may be used to transmit wireless signals in accordance with at least one desired radio access technology, such as 4G LTE, 5G NR, Wi-Fi, Bluetooth, RFID, etc. According to some example embodiments, the wireless antenna panel 3400 may also include a transponder (e.g., electronic tag, etc.) which allows the vehicle 3000 to communicate ITS service-related messages to an ITS node, such as ITS node 140, etc. In some example embodiments, the transponder may be separate from the wireless antenna panel 3400 and may use a separate radio access technology (e.g., the transponder may use RFID and/or Bluetooth communication protocol(s) to communicate with the ITS node 140 and the wireless antenna panel 3400 may be configured to transmit and/or receive data using 5G, 6G, Wi-Fi, etc.), but the example embodiments are not limited thereto. According to some example embodiments, the vehicle 3000 may transmit vehicle information (e.g., vehicle identification information (e.g., vehicle license plate information, vehicle identification number (VIN), a unique ITS identifier, an IP and/or MAC address assigned to the vehicle, etc.), current speed, current acceleration, current position, current occupancy level, desired destination, ITS subscription information, ITS billing information, requests for access to the reserved lane, etc.) to at least one ITS node, e.g., ITS node 140, at a desired time frequency, a desired distance traveled, etc., but is not limited thereto. For example, the vehicle 3000 may transmit the vehicle information and/or updated vehicle information, every 1 to 100 μs, etc., but the example embodiments are not limited thereto. The wireless communication between the vehicle 3000 and the ITS node 140 will be discussed in further detail in connection with FIGS. 4-5.

Additionally, the plurality of wireless antenna panels 3400 may be configured to transmit and/or receive data communications to one or more RAN nodes (not shown), but the example embodiments are not limited thereto. The plurality of wireless antenna panels and/or transponder 3400 may be located at the same or different physical locations on the body of the vehicle 3000, may have the same or different orientations, may operate in the same or different frequency ranges, may operate in accordance with the same or different radio access technology, etc. According to some example embodiments, the plurality of wireless antenna panels 3400 may be a single antenna, or may be a plurality of antennas, etc. Moreover, according to some example embodiments, the vehicle 3000 may further use non-RF based wireless transceivers to communicate ITS related messages, such as infrared transceivers, visible light communication (VLC) transceivers, LiFi transceivers, etc., but is not limited thereto.

While FIG. 3 depicts an example embodiment of a vehicle 3000, the vehicle is not limited thereto, and they may include additional and/or alternative architectures that may be suitable for the purposes demonstrated.

FIG. 4 illustrates a functional block diagram of example processing circuitry of an ITS-compatible vehicle according to at least one example embodiment. The example processing circuitry of FIG. 4 may correspond to the processing circuitry 2100 of an ITS node as illustrated in FIG. 2, but the example embodiments are not limited thereto, and the ITS node may employ alternative architectures, etc.

According to some example embodiments, the processing circuitry 4000 may be embodied as a specially programmed ITS FPGA, but the example embodiments are not limited thereto. The ITS FPGA 4000 may include a queueing system 4010, a geo-awareness/congestion estimator 4020, a token arrival unit 4030, a queue manager 4040, a geo-awareness/congestion database 4050, a token distribution unit 4060, and/or a node manager 4070, etc., but the example embodiments are not limited thereto, and the processing circuitry 4000 may include a greater or lesser number of constituent functional components then shown in FIG. 4.

In at least one example embodiment, the processing circuitry 4000 may receive traffic congestion information and/or vehicle information from at least one vehicle, such as vehicle 100, etc., and/or at least one request for access to the reserved lane of the desired road segment (e.g., a request token and/or a reserved lane request token, etc.) from the vehicle 100 via the congestion sensor 2600 and/or token sensor 2700, etc. Additionally, the processing circuitry 4000 may also receive traffic congestion information from at least one neighboring ITS node, such as ITS nodes 140B and/or 140C, etc., and/or an ITS central server, but the example embodiments are not limited thereto. According to some example embodiments, the traffic congestion information (e.g., traffic condition information, etc.) may include information regarding the presence or absence of traffic accidents on a desired road segment, the location information of the traffic accidents, information regarding the lanes affected by a traffic accident, road construction information for a desired road segment, average speed of vehicles on a desired road segment, the number of vehicles traveling on a desired road segment, the number of vehicles traveling on the reserved lane of the desired road segment, etc., but the example embodiments are not limited thereto. Additionally, the vehicle information may include information regarding the current position information of a desired vehicle, current speed information of the desired vehicle, current acceleration information of the desired vehicle, vehicle type information of the desired vehicle (e.g., motorcycle, passenger car, truck, commercial vehicle, bus, recreational vehicle (RV), caravan, mobile home, emergency vehicle, construction vehicle, etc.), vehicle occupancy information of the desired vehicle, billing information and/or ITS subscription information of the desired vehicle, destination information of the desired vehicle, etc., but the example embodiments are not limited thereto.

Moreover, the processing circuitry 4000 may receive ITS service-related information from the neighboring ITS node(s) and/or the ITS central server, such as output queues of reserved lane access requests/grants from one or more of the neighboring ITS node(s) (e.g., an upstream ITS node, a preceding ITS node and/or a previous ITS node based on a direction of travel of the road segment, etc.), queue management policies (e.g., queue management algorithms, etc.), priority policies, ITS subscriber information (e.g., information indicating which vehicles are active subscribers to the ITS service, etc.), etc., but the example embodiments are not limited thereto.

The access request tokens, received traffic congestion information (from the vehicle 100 and/or the neighboring ITS nodes 140B and/or 140C, etc.), traffic congestion sensor data (e.g., video from near-road cameras, traffic sensors, etc.) from the congestion sensors 2600, etc., and/or the output queue from the neighboring ITS node(s) may be input to the queueing system 4010 and/or the geo-awareness/congestion estimator 4020. The geo-awareness/congestion estimator 4020 may determine, in real-time and/or dynamically, whether there is any near-by traffic congestion (e.g., traffic congestion effecting travel conditions on the desired road segment associated with and/or corresponding to the ITS node 140, etc.) based on the access request tokens, received traffic congestion information, traffic congestion sensor data, and/or the received output queue from the neighboring ITS node, etc., but is not limited thereto. The geo-awareness/congestion estimator 4020 may then forward the determined local and/or near-by traffic congestion in the geo-awareness/congestion database 4050, the queue manager 4040 and/or node manager 4070, etc., but the example embodiments are not limited thereto.

The queueing system 4010 may store at least one first input queue, at least one second input queue, and at least one output queue in memory, such as memory 2300 of FIG. 2, but the example embodiments are not limited thereto. The first input queue may be an input queue for receiving access request tokens originating from and/or received from vehicles traveling on the desired road segment associated with the ITS node 140 that are requesting access to the reserved lane of the desired road segment, etc. According to some example embodiments, the access request token may include the vehicle information corresponding to the vehicle transmitting the access request token, but the example embodiments are not limited thereto. For example, the access request token may include vehicle information and/or a subset of vehicle information, such as vehicle identification information, vehicle type information, vehicle occupancy information, current location information, current speed information, current acceleration information, vehicle destination information, ITS subscriber information, and/or billing information, etc., but the example embodiments are not limited thereto. The second input queue may be an input queue for receiving access grant tokens (e.g., reserved lane access tokens, etc.) which have been granted by the previous neighboring ITS node, e.g., ITS node 140B and/or ITS node 140C, etc., but the example embodiments are not limited thereto. The access grant tokens may include the vehicle information included in the access request token and may include additional information, such as the date and/or time (e.g., timestamp, etc.) information associated with the grant of access to the reserved lane by the previous ITS node, and/or access expiration information, e.g., the date and/or time when the access to the reserved lane expires, the allocated distance the vehicle is allowed to travel on the reserved lane, the allocated amount of time the vehicle is allowed to travel on the reserved lane, the exit number and/or road segment identifier where the vehicle is required to exit the reserved lane, etc., but the example embodiments are not limited thereto. According to some example embodiments, the access expiration information may be the same as the desired destination indicated in the vehicle information of the access request token, but is not limited thereto, and for example, the ITS node may designate a different access expiration based on traffic congestion information, availability of access grant tokens, etc.

Additionally, the first input queue and/or the second queue may be sub-divided into one or more sub-queues. The sub-queues may be classified based on various priority levels (e.g., slow/medium/fast priority levels; etc.) and/or conditions related to the ITS reserved lane access, but are not limited thereto. For example, the sub-queues may be divided based on one or more of vehicle type information (e.g., request tokens received from slower moving vehicles, such as construction vehicles, RVs, trucks, buses, etc., may be queued in the slow input queue, and fast vehicles, such as motorcycles and/or vehicles traveling at a higher speed, etc., may be queued in the fast input queue, etc.), vehicle occupancy information (e.g., low occupancy, medium occupancy, and high occupancy, etc.), subscriber information (e.g., queueing request tokens from ITS service subscribers into a high priority queue, queueing request tokens from non-ITS service subscribers into a low priority queue, and/or queueing request tokens from emergency vehicles into an emergency priority queue, etc.), but the example embodiments are not limited thereto. Additionally, the first queue may be sub-divided based on the determined congestion level of the desired road segment, etc. For example, the first queue and/or second queue may include a low congestion sub-queue (e.g., light congestion), a medium congestion (e.g., moderate congestion) sub-queue, and/or a high congestion (e.g., severe congestion) sub-queue, etc., and the traffic congestion sub-queues may be combined with one or more of the other sub-queue classification types, etc. As an example, during low congestion periods (e.g., less than 10 vehicles are traveling on the desired road segment, etc.), the queue manager 4040 may give higher priority to faster vehicles in order to increase and/or maximize the number of vehicles traveling on the desired road segment, but during periods of high and/or severe congestion (e.g., more than 50 vehicles are traveling on the desired road segment, etc.), the queue manager 4040 may give higher priority to higher occupancy vehicles, such as buses, etc., in order to increase and/or maximize the number of occupants and/or passengers traveling through the desired road segment, but the example embodiments are not limited thereto.

The queue manager 4040 may decide the priority of serving the request tokens enqueued in the queues of the queueing system 4010 based on the queuing algorithms, priority levels, and/or queue LUTs, etc. For example, the queue manager 4040 may apply a first-come-first-served policy, wherein request tokens stored in the first input queue are dequeued (e.g., granted access to the reserved lane) based on the arrival order of the request tokens. As another example, the queue manager 4040 may apply a first-to-exit-first-served policy, wherein request tokens stored in the first input queue indicating that the destination of the vehicle is closer to the location of the desired road segment (and/or the vehicle will leave the reserved lane sooner in terms of time and/or distance) are dequeued first, etc. Additionally, the queue manager 4040 may apply a traffic congestion-based queuing policy, wherein the queue manager 4040 is aware of all locations of traffic congestion (e.g., traffic accidents, slowdowns, construction, etc.) and will dequeue vehicles participating in the congestion first, etc., but the example embodiments are not limited thereto.

Moreover, in some example embodiments, the queue manager 4040 may also proactively, dynamically, and/or independently, temporarily grant access to the reserved lane to a vehicle participating in a traffic congestion without receiving a request token from the vehicle, based on the determined real-time and/or dynamic traffic congestion information corresponding to the desired road segment. The temporary grant token may include the terms and/or conditions of the grant of access to the reserved lane, such as the access expiration information, written and/or verbal driving instructions for the driver of the vehicle (e.g., instructing the driver to access the reserved lane and informing the driver of when and/or where to exit the reserved lane, etc.) to be output using the vehicle's display 3700 and/or speakers 3600, etc., and/or autonomous vehicle instructions which provide commands for an autonomous vehicle to access the reserved lane and instructions for the autonomous vehicle to exit the reserved lane at the designated exit location and/or exit time, etc.

The token arrival unit 4030 may calculate, determine, and/or manage the number of access grant tokens available to be distributed to vehicles requesting access and/or traveling on the reserved lane of the desired road segment based on the access grant tokens stored in the second input queue, the traffic congestion information determined by the geo-awareness congestion estimator 4020, the arrival frequency of access request tokens, vehicle type information associated with the access grant tokens and the access request tokens, etc., but is not limited thereto. For example, the token arrival unit 4030 may calculate a desired and/or maximum access token capacity based on the total road capacity (e.g., the total number of vehicles the reserved lane of the desired road segment may handle at one time at a desired speed, etc.) subtracted by the lost token capacity (e.g., the number of vehicles traveling on the reserved lane with previously granted access tokens, etc.) and additional traffic loss (e.g., the desired distance between vehicles traveling on the reserved lane, the traffic congestion levels of the reserved lane, the current average speed of the vehicles traveling on the reserved lane, etc.), but the example embodiments are not limited thereto. In other example embodiments, the desired and/or maximum access token capacity may be a fixed number set by the ITS node 140, the ITS service central server, a governmental authority, and/or an operator of the road segment, etc. The token arrival unit 4030 then transmits the number of available access grant tokens to the token distribution unit 4060, which provides the access grant tokens to the queue manager 4040, which enables the queue manager 4040 to dequeue the access request tokens stored in the input queues based on the selected and/or relevant dequeuing policy. The queue manager 4040 then transmits the access grant tokens to the node manager 4070 which transmits the access grant tokens to the requesting vehicle via the wireless antenna array 2500, etc. Further, the queue manager 4040 may determine whether the vehicle corresponding to the access grant token will travel to the next (e.g., downstream) ITS node of the road network in the reserved lane based on the access expiration terms included in the access grant tokens, and if so, the queue manager 4040 will enqueue a copy of the access grant token in an output queue. Additionally, the queue manager 4040 may enqueue a request token corresponding to any vehicles which were not granted access to the reserved lane within the desired road segment (e.g., the assigned territory of the ITS node 140) and which did not expire before the end of the desired road segment, etc. In other words, if the destination and/or requested amount of time indicated in the access request token indicates that the vehicle desires to travel in the reserved lane in one or more succeeding (e.g., downstream) ITS nodes, the queue manager 4040 will enqueue the unprocessed access request token in the output queue when the corresponding vehicle exits the desired road segment (e.g., territory) of the ITS node 140. If the access request token will expire within the desired road segment (e.g., territory) of the ITS node 140, then the ITS node 140 will cancel the access request token because it is no longer valid. The node manager 4070 may dequeue and transmit the access grant tokens and/or unprocessed access request tokens stored in the output queue to the next ITS node at a desired frequency and/or desired time interval, e.g., between 1 to 100 μs, but the example embodiments are not limited thereto.

Additionally, the node manager 4070 may also monitor the access token status for the vehicles traveling on the reserved lane to ensure that the vehicles are complying with the access expiration terms for the access grant. For example, if the node manager 4070 determines that a vehicle has traveled on the reserved lane for a longer period of time and/or a longer distance than permitted by the access grant token, the node manager 4070 may issue a warning to be displayed on the display 3700 of the vehicle and/or audibly played through the speakers 3600 of the vehicle, bill the vehicle a monetary penalty using the stored billing information corresponding to the vehicle, and/or transmit the vehicle identification information to the relevant legal and/or police authority to provide a legal citation against the owner of the offending vehicle, etc.

FIG. 5 illustrate an example flowchart for operating an ITS node according to at least one example embodiment.

According to at least one example embodiment, in operation S5010, an ITS node, such as ITS node 140 of FIG. 1A, etc., may receive access request tokens from at least one vehicle traveling on a desired road segment associated with and/or proximate to the ITS node 140. The ITS node 140 may enqueue the received access request token based on priority information (e.g., traffic priority information, access priority information, ITS service subscriber information, etc.) and/or vehicle information included in the access request token, etc. In operation S5020, the ITS node 140 may determine traffic conditions for the desired road segment in real-time and/or dynamically based on the frequency and/or number of received access request tokens and/or observed traffic conditions using traffic cameras and/or traffic sensors associated with and/or corresponding to the ITS node 140. Optionally, or as an alternative to operation S5020, in operation S5030, the ITS node 140 may receive traffic condition from a preceding (e.g., upstream) ITS node, and the ITS node 140 may update and/or supplement the traffic condition information determined in operation S5020.

According to some example embodiments, operation S5010 may be optional and/or may be supplemented, and in operation S5020 and/or S5030, the ITS node 140 may independently and/or dynamically create an access request token on behalf of a vehicle based on the determined traffic conditions without receiving an access request token from the vehicle itself. For example, if the ITS node 140 determines that there is traffic congestion on the desired road segment, the ITS node 140 may automatically generate a temporary access request token for vehicles which may not be subscribed to the ITS service and/or which may not intend to use the ITS service, in order to clear the traffic congestion and/or improve the movement of vehicles and/or passengers through desired road segment, etc.

In operation S5040, the ITS node 140 may determine whether to dequeue an access request token stored in an input queue based on the determined traffic condition information and/or the vehicle information stored in the access request token, along with any applicable queueing algorithms, priorities, etc.

In operation S5050, the ITS node 140 may transmit a reserved lane access token (e.g., a grant token) to the vehicle corresponding to the dequeued access request token, thereby indicating that the vehicle is authorized to travel on the reserved lane. Additionally, in the event that the vehicle is an autonomous vehicle, the ITS node 140 may also transmit instructions and/or commands readable by the autonomous vehicle which cause the autonomous vehicle to enter the reserved lane, set the desired speed of travel for the autonomous vehicle, set the desired distance between vehicles traveling on the reserved lane, and/or set the location and/or time to exit the reserved lane for the autonomous vehicle, etc., but the example embodiments are not limited thereto. In operation S5060, the ITS node 140 may monitor the access grant tokens stored in the vehicles traveling in the reserved lane and may determine whether the vehicle is authorized to travel in the reserved lane based on the access expiration information included in the access grant token. In the event that the ITS node 140 determines that the vehicle is not authorized to travel in the reserved lane, e.g., based on the absence of a valid access grant token and/or the expiration of the access grant token, the ITS node 140 may transmit a warning to the vehicle instructing the vehicle to exit the reserved lane, may issue a monetary fine to the owner of the vehicle based on the subscription and/or billing information associated with the vehicle, and/or forward the vehicle information to the relevant legal and/or police authority for the issuance of a traffic citation, etc.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

1-20. (canceled)

21. An intelligent transportation system node comprising:
a memory storing computer readable instructions and a plurality of input queues, the
plurality of input queues including at least one first input queue associated with the node, and at least one second input queue associated with at least one preceding neighboring node; and
processing circuitry configured to execute the computer readable instructions to cause the node to,
determine traffic condition information associated with a desired segment of a road network, the road network including at least one reserved lane,
determine whether to dequeue at least one access request token from the plurality of input queues based on the determined traffic condition information and vehicle information corresponding to at least one vehicle associated with the at least one access request token, and
transmit at least one reserved lane access token from a set of reserved lane access tokens to at least one vehicle corresponding to the at least one dequeued access request token, the at least one reserved lane access token instructing the at least one vehicle to access to the reserved lane.

22. The node of claim 21, wherein
the vehicle information includes at least one of current position information corresponding to the at least one vehicle, current speed information corresponding to the at least one vehicle, current acceleration information corresponding to the at least one vehicle, vehicle type information corresponding to the at least one vehicle, occupancy information corresponding to the at least one vehicle, billing information corresponding to the at least one vehicle, destination information corresponding to the at least one vehicle, or any combinations thereof.

23. The node of claim 21, wherein the node is further caused to:
receive at least one first access request token from at least one first vehicle, the at least one first access request token including first vehicle information associated with the at least one first vehicle; and
enqueue the at least one first access request token in the at least one first input queue associated with the node.

24. The node of claim 23, wherein the node is further caused to:
receive at least one output queue from the at least one preceding neighboring node, the at least one output queue including at least one second reserved lane access token corresponding to at least one second vehicle which received access to the reserved lane from the at least one preceding neighboring node, the at least one second reserved lane access token including at least one second vehicle information corresponding to the at least one second vehicle;
enqueue the at least one second reserved lane access token in the at least one second input queue; and
determine the traffic condition information associated with the desired segment of the road network based on the first vehicle information and the second vehicle information.

25. The node of claim 24, wherein
the at least one reserved lane access token and the at least one second lane access token each includes access expiration information associated with the corresponding vehicle; and
the node is further caused to:
determine whether to revoke access for the at least one vehicle based on the access expiration information associated with the at least one reserved lane access token corresponding to the at least one vehicle, the revoking access including dequeuing the respective reserved lane access token from the at least one first input queue;
determine whether to revoke access for the at least one second vehicle based on the access expiration information associated with the at least one second reserved lane access token corresponding to the at least one second vehicle, the revoking access including dequeuing the respective reserved lane access token from the at least one second input queue;
combine the at least one first input queue and the at least one second input queue into an output queue; and
transmit the output queue to at least one succeeding neighboring node.

26. The node of claim 21, wherein the node further comprises:
at least one traffic camera configured to video record traffic conditions on the desired segment of the road network;
at least one traffic sensor configured to sense a number of vehicles travelling on the desired segment of the road network; and
the node is further caused to, determine the traffic condition information associated with the desired segment of the road network based on the video recorded traffic conditions and the sensed number of vehicles.

27. The node of claim 21, wherein the node is further caused to:
receive preceding traffic condition information corresponding to at least one preceding segment of the road network from at least one preceding neighboring node; and
determine the traffic condition information associated with the desired segment of the road network based on the preceding traffic condition information.

28. The node of claim 21, wherein the node is further caused to:
select the at least one access request token from the plurality of input queues to dequeue based on a dequeue policy, the dequeue policy being at least one of a first-come-first-served policy, a first-to-exit policy, a congestion-based queueing policy, and a priority-based queueing policy; and
dequeue the selected at least one access request token.

29. The node of any one of claims 21, wherein the node is further caused to:
determine a number of unallocated reserved lane access tokens in the set of reserved lane access tokens associated with the reserved lane; and
determine whether to dequeue the at least one access request token from the plurality of input queues based on the determined number of unallocated reserved lane access tokens.

30. A method of operating an intelligent transportation system node comprising:
determining traffic condition information associated with a desired segment of a road network, the road network including at least one reserved lane;
determining whether to dequeue at least one access request token from a plurality of input queues based on the determined traffic condition information and vehicle information corresponding to at least one vehicle associated with the at least one access request token,
the plurality of input queues including at least one first input queue associated with the node, and at least one second input queue associated with at least one preceding neighboring node; and
transmitting at least one reserved lane access token from a set of reserved lane access tokens to at least one vehicle corresponding to the at least one dequeued access request token, the at least one reserved lane access token instructing the at least one vehicle to access to the reserved lane.

31. The method of claim 30, wherein
the vehicle information includes at least one of current position information corresponding to the at least one vehicle, current speed information corresponding to the at least one vehicle, current acceleration information corresponding to the at least one vehicle, vehicle type information corresponding to the at least one vehicle, occupancy information corresponding to the at least one vehicle, billing information corresponding to the at least one vehicle, destination information corresponding to the at least one vehicle, or any combinations thereof.

32. The method of claim 30, further comprising:
receiving at least one first access request token from at least one first vehicle, the at least one first access request token including first vehicle information associated with the at least one first vehicle; and
enqueuing the at least one first access request token in the at least one first input queue associated with the node.

33. The method of claim 32, further comprising:
receiving at least one output queue from the at least one preceding neighboring node, the at least one output queue including at least one second reserved lane access token corresponding to at least one second vehicle which received access to the reserved lane from the at least one preceding neighboring node, the at least one second reserved lane access token including at least one second vehicle information corresponding to the at least one second vehicle;
enqueuing the at least one second reserved lane access token in the at least one second input queue; and
determining the traffic condition information associated with the desired segment of the road network based on the first vehicle information and the second vehicle information.

34. The method of claim 33, wherein
the at least one reserved lane access token and the at least one second lane access token each includes access expiration information associated with the corresponding vehicle; and
the method further comprising:
determining whether to revoke access for the at least one vehicle based on the access expiration information associated with the at least one reserved lane access token corresponding to the at least one vehicle, the revoking access including dequeuing the respective reserved lane access token from the at least one first input queue;
determining whether to revoke access for the at least one second vehicle based on the access expiration information associated with the at least one second reserved lane access token corresponding to the at least one second vehicle, the revoking access including dequeuing the respective reserved lane access token from the at least one second input queue;
combining the at least one first input queue and the at least one second input queue into an output queue; and
transmitting the output queue to at least one succeeding neighboring node.

35. The method of claim 30, further comprising:
video recording, using at least one traffic camera, traffic conditions on the desired segment of the road network;
sensing, using at least one traffic sensor, a number of vehicles travelling on the desired segment of the road network; and
determining the traffic condition information associated with the desired segment of the road network based on the video recorded traffic conditions and the sensed number of vehicles.

36. The method of claim 30, further comprising:
receiving preceding traffic condition information corresponding to at least one preceding segment of the road network from at least one preceding neighboring node; and
determining the traffic condition information associated with the desired segment of the road network based on the preceding traffic condition information.

37. The method of claim 30, further comprising:
selecting the at least one access request token from the plurality of input queues to dequeue based on a dequeue policy, the dequeue policy being at least one of a first-come-first-served policy, a first-to-exit policy, a congestion-based queueing policy, and a priority-based queueing policy; and
dequeuing the selected at least one access request token.

38. The method of claim 30, further comprising:
determining a number of unallocated reserved lane access tokens in the set of reserved lane access tokens associated with the reserved lane; and
determining whether to dequeue the at least one access request token from the plurality of input queues based on the determined number of unallocated reserved lane access tokens.

39. A vehicle comprising:
a memory storing computer readable instructions; and
processing circuitry configured to execute the computer readable instructions to cause the vehicle to,
transmit an access request token to at least one intelligent transportation system node, the access request token including vehicle information, the vehicle information including at least one of current position information corresponding to the vehicle, current speed information corresponding to the vehicle, current acceleration information corresponding to the vehicle, vehicle type information corresponding to the vehicle, occupancy information corresponding to the vehicle, billing information corresponding to the vehicle, destination information corresponding to the vehicle, or any combinations thereof; and
receive at least one reserved lane access token from the node in response to the access request token, the at least one reserved lane access token instructing the vehicle to access to the reserved lane.

40. The vehicle of claim 39, wherein
the vehicle is an autonomous vehicle;
the reserved lane access token includes at least one of a permitted amount of travel time on the reserved lane, a permitted travel distance on the reserved lane, or a combination thereof; and
the vehicle is further caused to,
autonomously drive on the reserved lane based on the at least one reserved lane access token.
